(19) United States
(12) Patent Application Publication
(10) Pub. No.: US 2021/0334024 A1
(43) Pub. Date: Oct. 28, 2021

(54) Transactional Memory Based Memory Page De-Duplication

(71) Applicant: International Business Machines Corporation, Armonk, NY (US)

(72) Inventors: Qi Zhang, Elmsford, NY (US); Gong Su, New York, NY (US); Arun Kwangil Iyengar, Yorktown Heights, NY (US)

(73) Assignee: International Business Machines Corporation, Armonk, NY (US)

(21) Appl. No.: 16/860,132

(22) Filed: Apr. 28, 2020

(51) Int. Cl. G06F 3/06; G06F 12/1018; G06F 9/52

(52) U.S. Cl. CPC G06F 3/0641; G06F 3/0608; G06F 9/526; G06F 3/0664; G06F 12/1018; G06F 3/0683

(57) ABSTRACT

A system, computer program product, and method are provided to de-duplicate one or more memory pages in parallel. Multiple de-duplication processes operate in parallel, with each de-duplication process operatively coupled to at least two data structures, and further leveraging transactional memory to mitigate access conflicts.

### BACKGROUND

The present embodiment(s) relate to de-duplication of memory pages. More specifically, the embodiment(s) relate to employing transactional memory and parallelism to support and enable the de-duplication among elements.

A virtual machine is a software implementation of a physical machine, and exhibits the behavior of a separate computer. The virtual machine is a self-contained operating environment that behaves as if it is a separate computer, while allowing the sharing of underlying physical machine resources between multiple virtual machines. Each virtual machine operates as a whole machine, while a host of the virtual machine(s) manages resources to support each virtual machine. For example, a virtual machine consists of CPUs, memory, and I/O slots that are a subset of a pool of available resources within a computer system. Each of the virtual machines within the computer system is capable of running a version of an operating system and a set of application workloads. Regardless of the virtual machine category, the software running inside the virtual machine is limited to the resources and abstractions provided by the virtual machine.

### SUMMARY

The embodiments include a system, computer program product, and method for identifying memory de-duplication opportunities, and selectively subjecting memory pages to de-duplication.

In one aspect, a computer system is provided with a processing unit operatively coupled to memory and an operating system to support virtual memory page de-duplication. A de-duplication mechanism, operatively coupled to the processing unit, supports first and second de-duplication processes operatively coupled to first and second elements, with the processes configured to operate in parallel. The de-duplication mechanism, via one or more of the first and second de-duplication processes, is configured to identify a first memory page and selectively de-duplicate the first memory page. The functionality of the de-duplication mechanism includes: searching a first data structure for a first matching entry that represents a relatively identical memory page to the first memory page, and in response to such an identification representing the first memory page and the first matching entry in the first data structure; and searching the a second data structure for a second matching entry relatively identical to the first memory page in response to absence of the first matching entry in the first data structure. If the first memory page is not present, the first memory page is inserted in the second data structure, and if the first memory page is determined to be present, the first memory page is removed from the second data structure and represented with a corresponding matching entry in the first data structure. The de-duplication mechanism leverages transactional memory to resolve concurrent access of the first and second data structures.

In another aspect, a computer program product is provided to de-duplicate one or more memory pages. The computer program product is provided with a computer readable storage device having embodied program code. A de-duplication mechanism supports first and second de-duplication processes operatively coupled to first and second elements, respectively, with the processes configured to operate in parallel. Program code is configured to identify a first memory page and selectively de-duplicate the first memory page. The functionality of the de-duplication includes the program code to: search a first data structure for a first matching entry that represents a relatively identical memory page to the first memory page, and in response to such an identification represent the first memory page and the first matching entry in the first data structure; and search a second data structure for a second matching entry relatively identical to the first memory page in response to absence of the first matching entry in the first data structure. If the first memory page is not present, the program code inserts the first memory page in the second data structure, and if the first memory page is present, the program code removes the first memory page from the second data structure and represents the first memory page with a corresponding matching entry in the first data structure. The program code leverages transactional memory to resolve concurrent access of the first and second data structures.

In yet another aspect, a method is provided for de-duplicating one or more memory pages in a computer system configured with a de-duplication mechanism supporting first and second de-duplication processes operatively coupled to first and second elements, respectively, with the processes configured to operate in parallel. A first memory page is identified and subject to selective de-duplication. The functionality of the de-duplication includes: searching a first data structure for a first matching entry that represents a relatively identical memory page to the first memory page, and in response to such an identification representing the first memory page and the first matching entry in the first data structure; and searching a second data structure for a second matching entry relatively identical to the first memory page in response to absence of the first matching entry in the first data structure. If the first memory page is not present, the first memory page is inserted in the second data structure, and if the first memory page is present, the first memory page is removed from the second data structure and represented with a corresponding matching entry in the first data structure. Transactional memory is leveraged to resolve concurrent access of the first and second data structures.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings reference herein forms a part of the specification. Features shown in the drawings are meant as illustrative of only some embodiments, and not of all embodiments, unless otherwise explicitly indicated.

FIG. 1 depicts a schematic diagram of a computer system to support parallel memory page de-duplication.

FIGS. 2A and 2B depict a flow chart illustrating a de-duplication process and the steps employed in the process.

FIG. 3A depicts a flow chart illustrating a process of starting a transactional memory based transaction.

FIG. 3B depicts a flow chart illustrating a process of stopping the transactional memory instruction.

FIGS. 4A and 4B depict a flow chart demonstrating application of a hash function to one or more memory pages in via of a corresponding data structure, e.g. the first and second data structures.

FIG. 5 is a block diagram depicting an example of a computer system/server of a cloud based support system, to implement the system and processes described above with respect to FIGS. 1-4B.

FIG. 6 depicts a block diagram illustrating a cloud computer environment.

FIG. 7 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiments. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

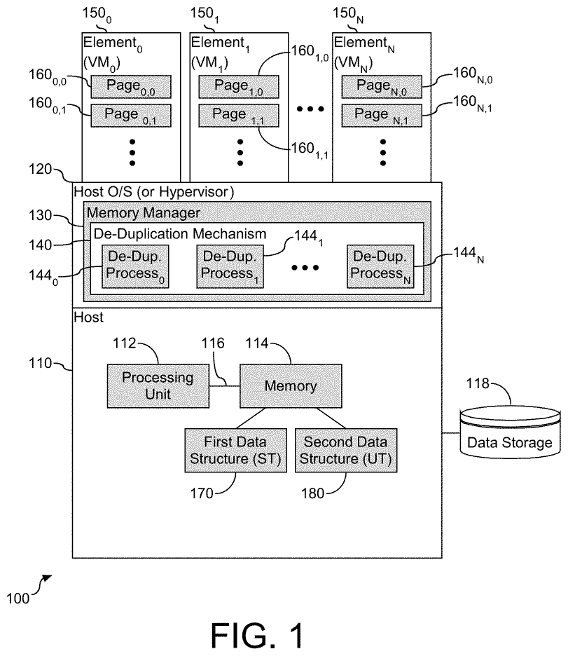

Referring to FIG. 1, a schematic diagram of a computer system (100) is depicted to support parallel memory page de-duplication. As shown, a server (110), also known as a host, is provided with a processing unit (112) operatively coupled to memory (114) across a bus (116), and in communication with one or more persistent storage devices (118). As shown, a host operating system, host O/S, (120) is provided for the host (110) and interacts with underlying hardware components. A memory manager (130) is shown embedded in the host O/S (120) and functions to support a memory page de-duplication mechanism (140). The memory manager (130) via the de-duplication mechanism (140) allows multiple de-duplication processes, or in an embodiment multiple threads, to run on a single host system (110) at the same time. The de-duplication processes are shown herein operating on an operatively coupled element, which can be a virtual machine, container, processes in a container, or any element or entity that manages memory on the operating system (120) or hypervisor (not shown). For descriptive purposes, the operatively coupled element is hereinafter referred to as an element. As shown herein by way of example, three de-duplication processes are provided, including de-duplication process₀ (144₀), de-duplication process₁ (144₁), and de-duplication process_{N} (144_{N}), although this quantity should not be considered limiting.

A plurality of elements are shown operatively coupled to the host (110) via the host O/S (120), including element₀ (150₀), element₁ (150₁), and element_{N} (150_{N}). Each element is a platform to run application and programs. For example, in an embodiment, one or more of the elements may be a virtual machine or a container. Although three elements are shown herein, the quantity should not be considered limiting. Each element is operatively coupled to a corresponding de-duplication process via the de-duplication mechanism (140). For example, element₀ (150₀) is operatively coupled to de-duplication process₀ (144₀), element₁ (150₁) is operatively coupled to de-duplication process₁ (144₁), and element (150_{N}) is operatively coupled to de-duplication process_{N} (144_{N}).

A page of memory is a fixed number of bytes and represents a unit of data for memory management in a virtual memory operating system. Memory de-duplication is a technique which merges identical memory pages to save a physical memory resource. As shown herein, each element represented herein as element₀ (150₀), element₁ (150₁), and element_{N} (150_{N}) is shown with a plurality of memory pages to support corresponding workloads. By way of example, element₀ (150₀) is shown with page_{0,0} (160_{0,0}) and page_{0,1} (160_{0,1}), element₁ (150₁) is shown with page_{1,0} (160_{1,0}), and page_{1,1} (160_{1,1}), and element_{N} (150_{N}) is shown with page_{N,0} (160_{N,0}) and page_{N,1} (160_{N,1}). Although each element is shown with two pages, this quantity is not limiting. It is understood that there may be identical memory pages among the at least two elements due to similar workloads.

As shown and described herein, two or more de-duplication processes (144₀), (144₁), and (144_{N}) are configured to run in parallel. Each de-duplication process (144₀), (144₁), and (144_{N}) is responsible for scanning memory pages of an operatively coupled element. By way of example, de-duplication process₀ (144₀) is responsible for scanning pages (160_{0,0}) and (160_{0,1}) of element₀ (150₀), de-duplication process₀ (144₁) is responsible for scanning pages (160_{1,0}) and (160_{1,1}) of element₁ (150₁), and de-duplication process_{N} (144_{N}) is responsible for scanning pages (160_{N,0}) and (160_{N,1}) of element_{N} (150_{N}). The de-duplication mechanism (140) functions to identify whether any page from one of the elements is identical to another page from either the same element or the other elements on the same physical machine, e.g. host (120). Memory pages are processed for de-duplication, and during this process they are subject to a comparison. However, in order to compare the pages or to compare the pages in an efficient manner, the comparison needs to evaluate similar objects. As shown and described herein, a hash function is leveraged to generate a hash code for the individual memory pages. Each of the de-duplication processes, e.g. (144₀), (144₁), and (144_{N}), may individually leverage the hash function to generate a hash code for an individual memory page. It is understood in the art that a hash code is a numeric value, e.g. number, generated from any object. In this case, the hash code is generated for individual memory pages, and as described herein is used in identification of the memory pages during equality testing. Two objects are considered equal if they return equal hash codes. In the case of virtual machines or elements and corresponding virtual memory pages, two virtual memory pages are considered equal if they return equal hash codes. Accordingly, the hash function is used herein to map an individual virtual memory page to a fixed size value.

The values, e.g. hash codes, are used to represent the memory page(s). In an embodiment, a logical expression is utilized to compress or decrease the size of the generated hash code. When multiple de-duplication processes are running on the same physical machine, they need to collaborate with each other to detect identical pages among different elements (150₀), (150₁), . . . (150_{N}). Concretely speaking, the de-duplication processes need to access two or more data structures in a shared manner. In an embodiment, the data structures are in the form of hash tables. The data structures are shared among the de-duplication processes to organize and manage memory pages for de-duplication. As shown and described herein, the data structures are referred to herein as a first data structure (170), e.g. first hash table or stable hash table, and a second data structure (180), e.g. second hash table or unstable hash table. The second data structure (180) stores all the memory pages that have been scanned by one of the de-duplication processes but cannot be or has not been subject to a merge with another memory page since no other identical memory page has been detected, while the first data structure (170) stores memory pages that have been merged. The first and second data structures, (170) and (180), respectively, shown and described herein are open hash tables, also known as a disjoint-set data structure which is a data structure that keeps track of a set of elements partitioned into a number of disjoint (non-overlapping) subsets. The disjoint-set data structure is a data structure representing a dynamic collection of sets. The disjoint-set data structure supports operations that create a new set containing a single element, returning a representative element, and replacing a first element in a first set and a second element in a second set with a union in the collection of sets.

As shown in FIG. 1, both the first and second structures (170) and (180), respectively, are shown operatively coupled to memory (114). The second structure (180) is initially empty, e.g. not populated. Entries in the second structure (180) represent one or more non-merged memory pages, and entries in the first structure (170) represent merged memory pages. As pages are subject to processing, the first structure (170) and the second structure (180) are selectively populated. Each entry in the data structure, whether the first structure (170) or the second structure (180), represents a memory page, with the entry identifying the page. The hash value of a page is used as its key, which is further used to map a page to a slot in the hash table. It is understood that the hash value of two different pages may have the same hash value, and to address this aspect, the hash table design and functionality is extended to allow duplicate keys. The entry identifying the page is a page identifier. The entry identifying the value is a pointer, or in one embodiment a list of pointers, to a page address. In an embodiment of multiple pointers, the page address represents a merge of multiple identical pages to one address. Accordingly, each entry in one of the first and second structure (170) and (180), respectively, includes a page identifier, a hash code, and at least one pointer to a page address.

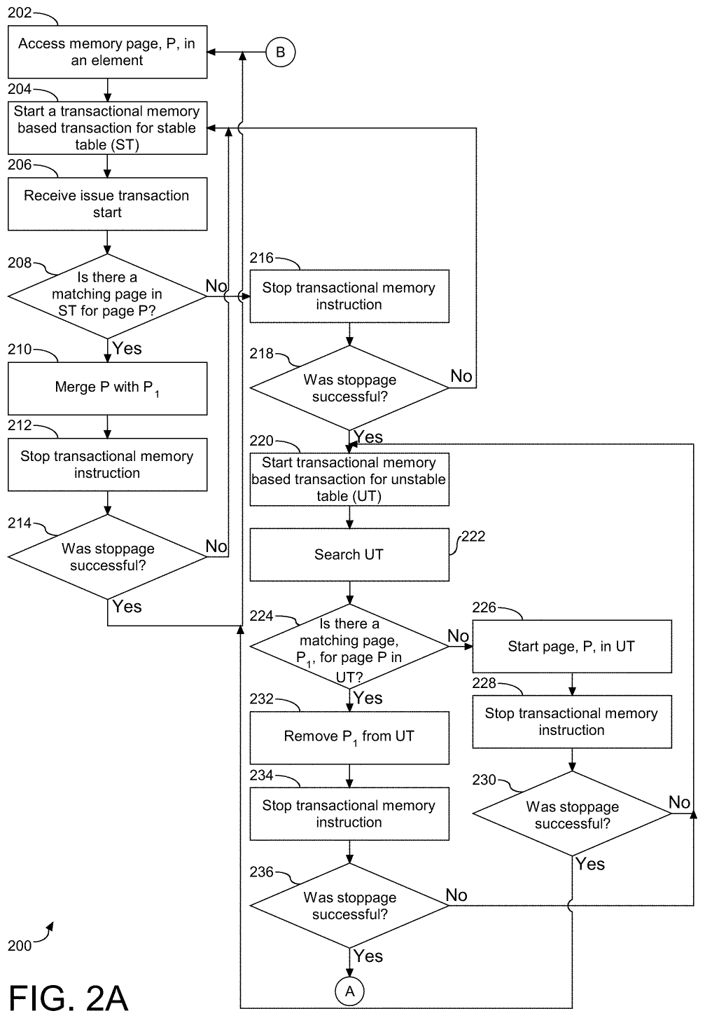

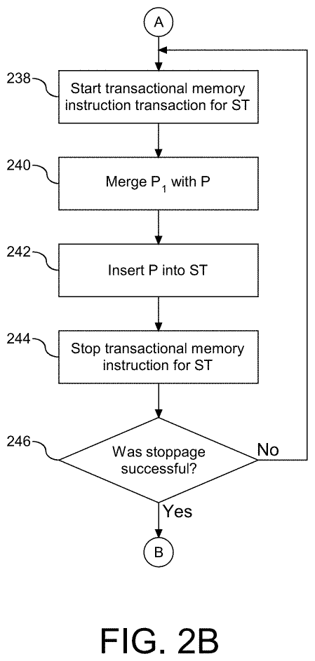

Both the first and second structures (170) and (180), respectively, are accessible by each of the de-duplication processes (144₀), (144₁), and (144_{N}). The de-duplication processes (144₀), (144₁), and (144_{N}), collaborate to merge pages within each operatively coupled element (150₀), (150₁), . . . (150_{N}), including intra-element and across different elements, e.g. inter-element. As a memory page within or associated with one or more of the elements is assessed for de-duplication, the corresponding de-duplication process leverages a hash function to generate a hash code for the memory page. For example, page_{0,0} (160_{0,0}) is local to element_{0,0} (150₀), and as such is processed by de-duplication process₀ (144₀) to generate a corresponding hash code, with the hash code being a representation of the memory page. The de-duplication is directed two or more of the de-duplication processes, e.g. (144₀), (144₁), and (144_{N}), operating in parallel, and accessing the first and second data structures (170) and (180), respectively, in parallel. The access of the data structures includes reading the entries therein, or in an embodiment, writing to the data structures to add, remove, or amend an entry therein. Duplicate entries as identified by their corresponding hash code representation are stored in the first structure (170) and non-duplicate entries are stored in the second structure (180). Details of the comparison and de-duplication, including conflict resolution via transactional memory associated with two or more de-duplication processes accessing the same data structure, are shown and described in FIGS. 2A-4. Accordingly, multiple de-duplication processes are shown herein to collaborate to merge memory pages through use of disjoint-set data structures, and to leverage transactional memory to guarantee correctness of concurrent data structure access from multiple de-duplication processes.

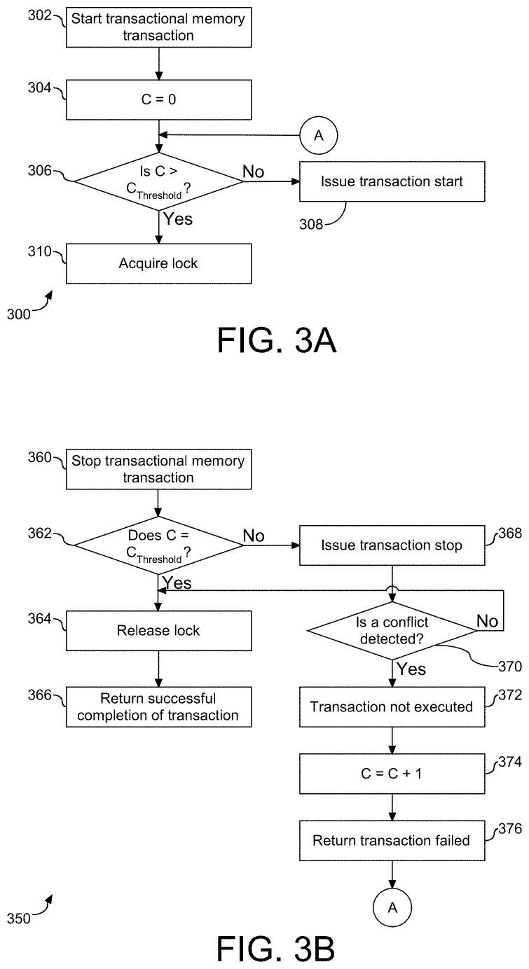

Referring to FIGS. 2A and 2B, a flow chart (200) is provided to illustrate the de-duplication process and the steps employed in the process. As shown and described in FIG. 1, a host is provided with two or more de-duplication processes operatively coupled to corresponding elements via the memory manager (130), with each element having one or more memory pages to support transactions. At least one of the de-duplication processes accesses a memory page, p, in a corresponding element (202). For example, in an embodiment, the de-duplication process₀ (144₀) assigned or associated with the first element, element₀ (150₀), accesses memory page (160_{0,0}). A transactional memory based transaction is started for the first data structure (204). Referring to FIG. 3A, a flow chart (300) is provided to illustrate the process of starting the transactional memory based transaction. As shown, after a transactional memory transaction has started (302), a counter variable, C, is initialized (304), followed by an assessment of whether the counter value has exceeded a configurable threshold, C_{Threshold} (306). A negative response to the assessment is followed by issuing a transaction start command (308), and a positive response is followed by acquiring a lock on the corresponding data structure, which in this case is the first data structure (310). Following either step (306) or step (308), the process of starting the transaction has concluded, and the process returns to FIG. 2A where a communication or instruction has been received to issue a transaction start directed at the first data structure (206). Accordingly, transactional memory is utilized as a primary tool for accessing the first data structure.

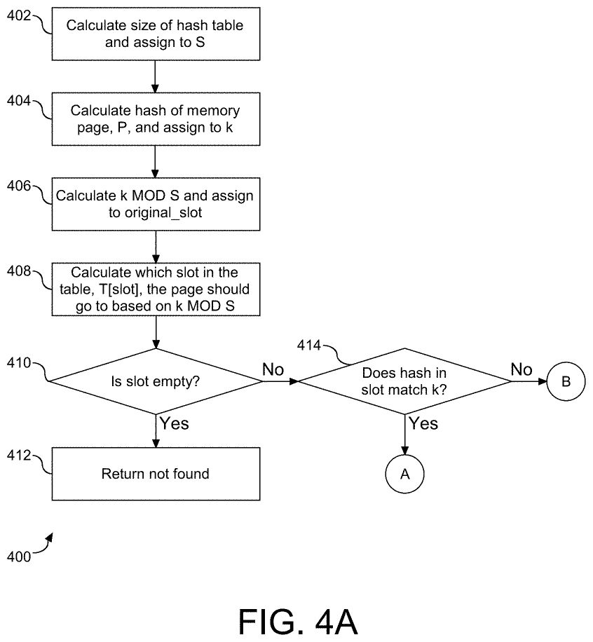

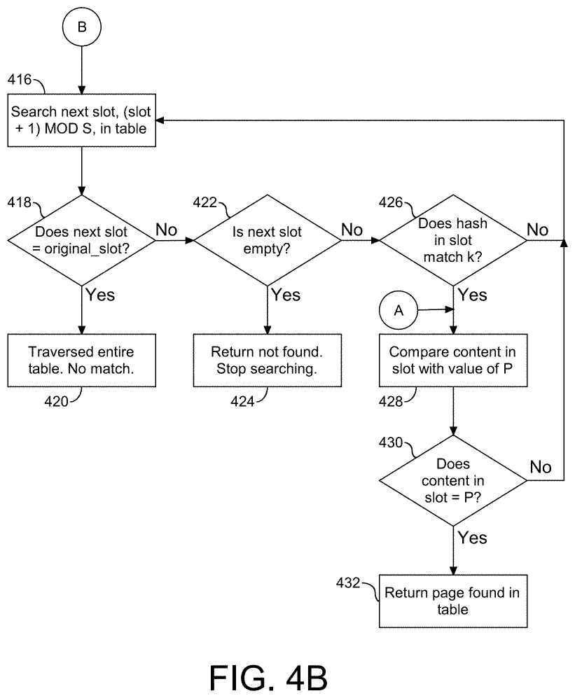

As shown and described in FIG. 1, the de-duplication mechanism (130) via one or more of the de-duplication processes leverages a hash function to process the memory pages for de-duplication. Referring to FIGS. 4A and 4B, a flow chart (400) is provided to illustrate a process for applying a hash function to one or more memory pages referenced in a corresponding data structure, e.g. the first and second data structures. As shown, a size, S, of the data structure that is the subject of the de-duplication is calculated (402). A hash function is leveraged to generate a hash code for the memory page, p, and the hash is assigned to a variable, e.g. k, (404). Following step (404), the hash code value from step (404) is used to calculate which slot in the data structure, e.g. hash table, the memory page should be assigned based on the following operation: k MOD S, where k is the hash value and S is the size of the data structure, e.g. hash table, (406). The function, MOD, applied to the memory page is a modulus operation that is applied to the hash value of the memory page, e.g. k. Two hashed memory pages, e.g. page₀ and page₁, are preliminarily considered duplicate if k₀ MOD S is the same value as k₁ MOD S. The value determined at step (406) is used to identify which slot in the corresponding data structure the memory page should be assigned (408). Accordingly, the hash value is subject to an operation for slot or location identification within the corresponding data structure.

Each slot in the table can be in one of the following states: empty, occupied, or tombstone. An empty state means that no element has been inserted into this slot, an occupied state means that there is currently an element in this slot, and a tombstone state means there was an element in this slot, but the element was previously deleted and the slot is now empty. As shown and described herein, the starting position for the search is k MOD S. During the search, if the slot is occupied an assessment is conducted to determine if the elements match, if the slot is a tombstone slot, the slot is skipped and the search proceeds to the next slot, and if the slot is empty the search concludes.

Following step (408), an assessment is conducted to determine if the slot identified at step (408) is empty in the corresponding data structure (410). A positive response to the determination is an indication that no entry was found in the identified slot (412), and the process returns to step (208) in FIG. 2A. However, a negative response to the determination is followed by a comparison to determine if the hash value in the identified slot matches the hash value of the page that is the subject of the processing, e.g. k, (414). A positive response to the determination at step (414) proceeds to the assessment shown and described below in step (428). However, a negative response to the determination at step (414) is followed by continued searching of the data structure. In an embodiment, it is understood that a proximally positioned slot in the data structure may be utilized to store pages having similar or close values. As shown, following the negative response at step (414), the next slot or entry in the data structure is searched with respect to the k MOD S value of the next slot (416). It is then determined if the entire data structure has been searched (418). A positive response to the determination at step (418) is an indication that the entire structure was searched and no match was found (420), and the process returns to step (208) of FIG. 2A. Similarly, a negative response to the determination at step (418) is followed by identifying if the slot under consideration is empty (422). A positive response to the determination at step (422) is followed by an indication that a match was not found (424), and the process returns to step (208) of FIG. 2A.

A negative response to the determination at step (422) is followed by a further assessment of the entry found in the data structure. The initial assessment is identification of matching values of k MOD S. It is understood that similar, but not identical, memory pages may have the same k MOD S value, but different hash value, e.g. meaning they are different memory pages. As shown, following the negative response to the determination at step (422), it is determined if the hash values of the page being searched and the page in the slot match (426). A negative response to the determination at step (426) is an indication that the hash values do not match and is followed by a return to step (416) to ascertain if there is another slot in data structure that may have a matching object, and a positive response is followed by a comparison of the content in the slot with the hash value of the memory page under consideration, e.g. p, (428). It is then determined if the contents match (430). A negative response to the determination at step (430) is followed by a return to step (416), and a positive response is followed by a return of the page found in the data structure (432), and a returned to step (208) in FIG. 2A.

As shown and described in FIGS. 4A and 4B, the data structure, e.g. hash table, is evaluated to identify if there is a matching memory page. Returning to FIG. 2A, the first data structure is subject to the evaluation shown and described in FIGS. 4A and 4B to determine if there is a matching memory page, p₁, for memory page p (208). A positive response to the determination at step (208) is followed by merging memory page p with memory page p₁ in the first data structure (210), and stopping the transactional memory instruction (212). Referring to FIG. 3B, a flow chart (350) is shown to illustrate the process of stopping a transactional memory instruction. As shown, following receipt of a stop transactional memory transaction instruction (360), it is determined if the value of the counter, C, is equal to the counter threshold, C_{Threshold}, (362). A positive response to the determination at step (362), is an indication that a lock was acquired in response to the start transactional memory instruction at step (204). The previously acquired lock is released (364), and a successful completion of the transaction is returned (366). However, a negative response to the determination at step (362) is followed by issuance of a transaction stop command (368), and an assessment to determine if a conflict has been detected with respect to use of the data structure (370). A negative response to the determination at step (370) is followed by a return to step (364), and a positive response is followed by non-execution of the transaction (372) and an increment of the counter value (374). Thereafter, a transaction failed command is returned (376), and the process returns to step (306) of FIG. 3A to either issue a transactional memory start instruction or to acquire a lock for the subject data structure.

Returning to FIG. 2A, following step (212), it is determined if the stop transactional memory instruction was successful (214). A negative response to the determination at step (214) is followed by a return to step (204), e.g. FIG. 3A, and a positive response is followed by a return to step (202). However, a negative response to the determination at step (208) is followed by issuing a step transactional memory instruction (216), e.g. FIG. 3B, and determining if the instruction was successful (218). The negative response at step (208) represents that there is no matching entry for the subject memory page in the first data structure. A negative response to the determination at step (218) is followed by a return to step (204), e.g. FIG. 3A, and a positive response to the determination at step (218) is followed by issuing a start transactional memory based transaction for the second data structure (220), e.g. FIG. 3A, and a search of the second data structure (222). It is then determined if there is a matching page, p₁, for page p in the first data structure (224). A negative response to the determination at step (224) is followed by inserting memory page p in the second data structure (226) and issuing a stop transactional memory instruction (228), e.g. FIG. 3B. It is then determined if the instruction at step (228) was successful (230). A negative response to the determination at step (230) if followed by a return to step (220), and a positive response is followed by a return to step (202). Accordingly, if there is no matching memory page found in either the first or second data structures, then an entry for memory page p is created in the second data structure.

A positive response to the determination at step (224) is an indication that memory page p and memory page p₁ are identical and subject to de-duplication. As shown, memory page p₁ is removed from the first data structure (232), and a stop transactional memory instruction is issued, e.g. FIG. 3B, (234). It is then determined if the removal of memory page p₁ from the second data structure was successful (236). A negative response to the determination at step (236) is followed by a return to step (220), e.g. FIG. 3A, and a positive response to the determination at step (236) is followed by issuance of a start transaction memory instruction, e.g. FIG. 3A, for the first data structure (238). With either transactional memory or an acquired lock, memory pages p and p₁ are merged (240), an entry for memory page p is created in the first data structure (242), and a stop transactional memory instruction is issued (244), e.g. FIG. 3B. It is then determined if the memory page merge in the first data structure was successful (246). A negative response to the determination at step (246) is followed by a return to step (238), and a positive response is followed by a return to step (202). Accordingly, as duplicate pages are identified in the second data structure, they are subject to merging and creation of a merged entry in the first data structure.

The data structures shown and described herein are two separate data structures, also referred to herein as structures, e.g. first structure (170) and second structure (180), and are created and utilized herein with respect to memory page de-duplication. In one embodiment, the first structure (170) is also referred to herein as a stable table (ST) and the second structure (180) is referred to herein as an unstable table (UT). Both the first and second structures (170) and (180), respectively, are each disjoint-set data structures. The UT and the ST are shared among two or more de-duplication processes, and as such two or more de-duplication processes may access the UT and ST in parallel. The UT originates as an empty table, e.g. non populated, and becomes populated as memory pages are subject to hash functions and corresponding hash codes are selectively populated into the UT. As the UT is selectively populated, the entries in the UT include non-merged memory pages, e.g. no identical memory pages. In contrast to the UT, the ST is a data structure wherein the entries are merged memory pages, e.g. the ST represents pages that have been merged. An entry in the ST may represent two or more memory pages. Accordingly, the UT and the ST are utilized in conjunction with the hash code representation of the pages to facilitate and enable the de-duplication.

The process of creating entries in both the UT and the ST is challenging since the UT and ST are shared by at least two de-duplication processes. At any one time, at least two or more de-duplication processes may be reading and writing data to the UT and/or the ST in parallel. Reading data from either or both the UT and the ST will not cause a conflict, however a conflict may arise when removing an entry from the UT or ST or creating an entry in the UT or ST. As shown in FIGS. 2A and 2B transactional memory is utilized to resolve the conflict and in select circumstances a lock may be acquired to complete the transaction.

As demonstrated herein, the de-duplication of the memory pages utilizes separate de-duplication processes for each element, which in one embodiment may be a virtual machine, while allowing the de-duplication processes to access, e.g. read, the UT and ST in parallel. The memory of each element is processed by a single de-duplication process. Multiple de-duplication processes collaborate to merge memory pages not only within each element, but also across different elements. As shown in FIG. 1, the ST and the UT are global structures (170) and (180), respectively, local to the host (110). The global characteristics of the UT and the ST enables and supports access by all of the de-duplication processes in parallel to identify and merge identical pages, thereby de-duplicating identical pages. Although the process shown and described in FIGS. 2A and 2B illustrates a single memory page access by a single process or thread, it is understood that multiple processes and threads may invoke this process in parallel and as such leverage the first and second data structures in parallel. At the same time and as described herein, because the UT and ST are globally accessible to each de-duplication process operating on the host (110), conflicts may arise. Transactional memory is utilized to resolve such conflicts when writing to the UT and ST. The transactional memory guarantees the correctness of concurrent data structure access from multiple de-duplication processes.

Transactional memory solves concurrent access conflicts in an efficient and convenient manner. Page comparison operations described herein are also referred to as a read operation, and UT and ST table modifications that include adding an entry or removing an entry are also referred to as write operations. In one embodiment, the quantity of read operations on the ST and UT may exceed the quantity of write operations on the ST and UT. As shown and described in FIGS. 3A and 3B, in an embodiment a lock on the ST and/or UT may be employed to resolve a conflict. However, the use of transactional memory solves concurrent access conflicts at a lower cost than that of the locks.

As shown and described in FIGS. 1-4, systems and processes are provided to support memory page de-duplication. It is understood that de-duplication reduces costs of a cloud service provider by mitigating duplication memory pages, and increases memory resource utilization. In an embodiment, cloud service performance may be improved or enhanced by hosting additional elements, or an embodiment VMs, on a given set of hardware.

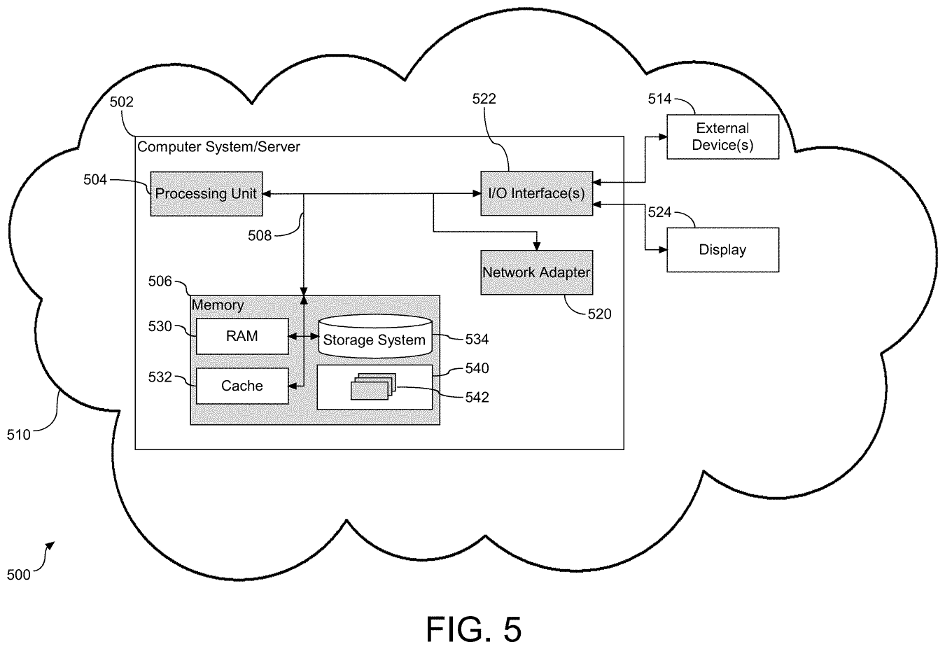

With references to FIG. 5, a block diagram (500) is provided illustrating an example of a computer system/server (502), hereinafter referred to as a host (502) in communication with a cloud based support system, to implement the system and processes described above with respect to FIGS. 1-4. Host (502) is operational with numerous other general purpose or special purpose computing system environments or configurations. Examples of well-known computing systems, environments, and/or configurations that may be suitable for use with host (502) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

Host (502) may be described in the general context of computer system-executable instructions, such as program modules, being executed by a computer system. Generally, program modules may include routines, programs, objects, components, logic, data structures, and so on that perform particular tasks or implement particular abstract data types. Host (502) may be practiced in distributed cloud computing environments (510) where tasks are performed by remote processing devices that are linked through a communications network. In a distributed cloud computing environment, program modules may be located in both local and remote computer system storage media including memory storage devices.

As shown in FIG. 5, host (502) is shown in the form of a general-purpose computing device. The components of host (502) may include, but are not limited to, one or more processors or processing units (504), a system memory (506), and a bus (508) that couples various system components including system memory (506) to processor (504). Bus (508) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (502) typically includes a variety of computer system readable media. Such media may be any available media that is accessible by host (502) and it includes both volatile and non-volatile media, removable and non-removable media.

Memory (506) can include computer system readable media in the form of volatile memory, such as random access memory (RAM) (530) and/or cache memory (532). By way of example only, storage system (534) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (508) by one or more data media interfaces.

Program/utility (540), having a set (at least one) of program modules (542), may be stored in memory (506) by way of example, and not limitation, as well as an operating system, one or more application programs, other program modules, and program data. Each of the operating systems, one or more application programs, other program modules, and program data or some combination thereof, may include an implementation of a networking environment. Program modules (542) generally carry out the functions and/or methodologies of embodiments of the de-duplication mechanism shown and described in FIGS. 1-4. For example, the set of program modules (542) may include the functionality of the de-duplication processes described in FIG. 1.

Host (502) may also communicate with one or more external devices (514), such as a keyboard, a pointing device, a sensory input device, a sensory output device, etc.; a display (524); one or more devices that enable a user to interact with host (502); and/or any devices (e.g., network card, modem, etc.) that enable host (502) to communicate with one or more other computing devices. Such communication can occur via Input/Output (I/O) interface(s) (522). Still yet, host (502) can communicate with one or more networks such as a local area network (LAN), a general wide area network (WAN), and/or a public network (e.g., the Internet) via network adapter (520). As depicted, network adapter (520) communicates with the other components of host (502) via bus (508). In one embodiment, a plurality of nodes of a distributed file system (not shown) is in communication with the host (502) via the I/O interface (522) or via the network adapter (520). It should be understood that although not shown, other hardware and/or software components could be used in conjunction with host (502). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (506), including RAM (530), cache (532), and storage system (534), such as a removable storage drive and a hard disk installed in a hard disk drive.

Computer programs (also called computer control logic) are stored in memory (506). Computer programs may also be received via a communication interface, such as network adapter (520). Such computer programs, when run, enable the computer system to perform the features of the present embodiments as discussed herein. In particular, the computer programs, when run, enable the processing unit (504) to perform the features of the computer system. Accordingly, such computer programs represent controllers of the computer system.

In one embodiment, host (502) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

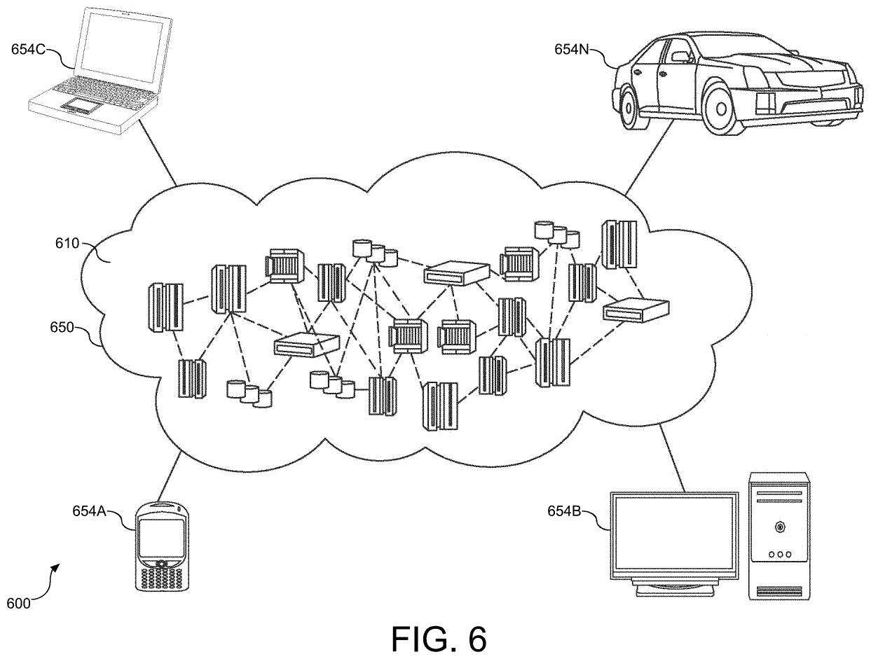

Referring now to FIG. 6, an illustrative cloud computing network (600). As shown, cloud computing network (600) includes a cloud computing environment (650) having one or more cloud computing nodes (610) with which local computing devices used by cloud consumers may communicate. Examples of these local computing devices include, but are not limited to, personal digital assistant (PDA) or cellular telephone (654A), desktop computer (654B), laptop computer (654C), and/or automobile computer system (654N). Individual nodes within nodes (610) may further communicate with one another. They may be grouped (not shown) physically or virtually, in one or more networks, such as Private, Community, Public, or Hybrid clouds as described hereinabove, or a combination thereof. This allows cloud computing environment (600) to offer infrastructure, platforms and/or software as services for which a cloud consumer does not need to maintain resources on a local computing device. It is understood that the types of computing devices (654A-N) shown in FIG. 6 are intended to be illustrative only and that the cloud computing environment (650) can communicate with any type of computerized device over any type of network and/or network addressable connection (e.g., using a web browser).

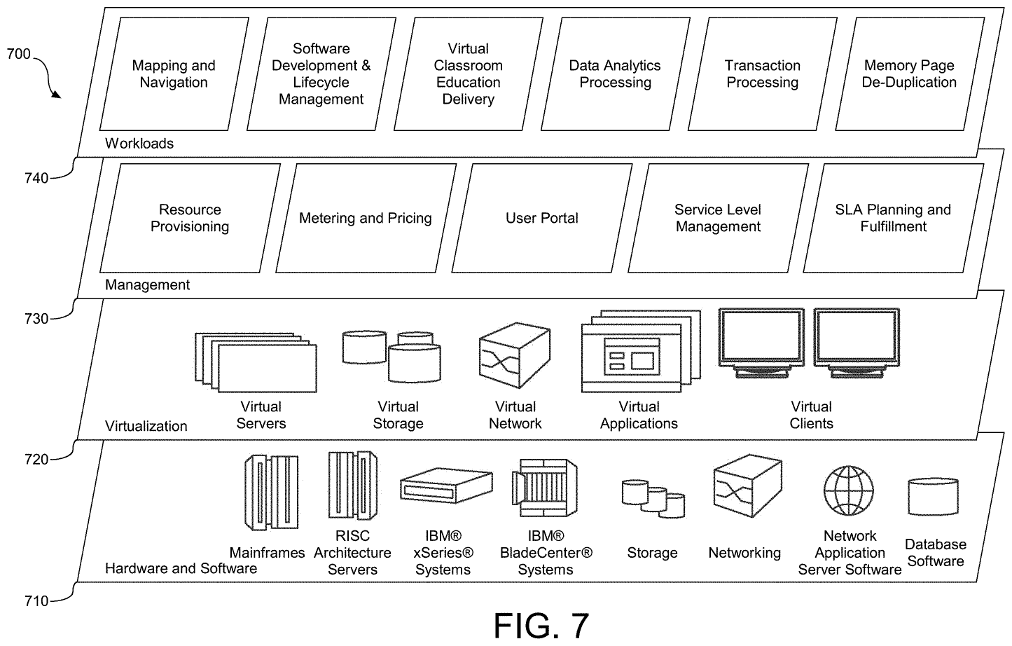

Referring now to FIG. 8, a set of functional abstraction layers (800) provided by the cloud computing network of FIG. 6 is shown. It should be understood in advance that the components, layers, and functions shown in FIG. 7 are intended to be illustrative only, and the embodiments are not limited thereto. As depicted, the following layers and corresponding functions are provided: hardware and software layer (710), virtualization layer (720), management layer (730), and workload layer (740). The hardware and software layer (710) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (720) provides an abstraction layer from which the following examples of virtual entities may be provided: virtual servers; virtual storage; virtual networks, including virtual private networks; virtual applications and operating systems; and virtual clients.

In one example, management layer (730) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (740) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and memory page de-duplication.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

The present invention may be a system, a method, and/or a computer program product. In addition, selected aspects of the present invention may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present invention may take the form of computer program product embodied in a computer readable storage medium (or media) having computer readable program instructions thereon for causing a processor to carry out aspects of the present invention. Thus embodied, the disclosed system, a method, and/or a computer program product are operative to improve the functionality and operation of information retrieval by directing activity, and in one embodiment authoring activity, towards identified gaps in corpora of knowledge.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments of the invention have been described herein for purposes of illustration, various modifications may be made without departing from the spirit and scope of the invention. In particular, the first and second structures (170) and (180) may be modified so that each entry can be associated with a list, and the items in the list represent the memory pages with the same hash value but different content. Accordingly, the scope of protection of this invention is limited only by the following claims and their equivalents.

What is claimed is:

1. A computer system to de-duplicate one or more memory pages comprising:
a processing unit operating coupled to memory and an operating system;
a de-duplication mechanism operatively coupled to the processing unit, the de-duplication mechanism to support first and second de-duplication processes operatively coupled to first and second elements, respectively, and configured to operate in parallel;
the de-duplication mechanism operatively coupled to the processing unit, via one or more of first and second de-duplication processes, to identify a first memory page and selectively de-duplicate the first memory page, including:
search a first data structure for a first matching entry representing a relatively identical memory page to the first memory page:
in response to identification of the first matching entry relatively identical to the first memory page, represent the first memory page and the first matching entry in the first data structure;
search a second data structure for a second matching entry relatively identical to the first memory page in response to absence of the first matching entry in the first data structure, and:
in response to absence of the first memory page, insert the first memory page in the second data structure; and
in response to presence of the first memory page, remove the first memory page from the second data structure, and represent the first memory page with a corresponding matching entry in the first data structure; and
the de-duplication mechanism to leverage transactional memory to resolve concurrent access of the first and second data structures.

2. The computer system of claim 1, further comprising the de-duplication mechanism to create a first hash code representation of one or more memory pages local to the first element, and create a second hash code representation of one or more memory pages local to the second element.

3. The computer system of claim 1, wherein the first and second data structures are disjoint-set data structures, each representing a dynamic collection and supporting operations to create a new set containing a single element, return a representative element, and replace a first element in a first set and a second element in a second set with a union in the dynamic collection.

4. The computer system of claim 2, wherein the relatively identical memory page includes application of a modulus operation to the first memory page based on a corresponding data structure size, and the de-duplication mechanism to compare a value from the applied modulus operation to one or more entries in the corresponding data structure.

5. The computer system of claim 4, wherein selective de-duplication of the first memory page includes a two phase comparison wherein the value from the applied modulus operation is a first phase comparison, and further comprising the de-duplication mechanism to apply a second phase comparison responsive to relatively matching the first memory page with a page entry in one of the data structures, the second phase including comparison of content of the first memory page with content of the page entry in one of the data structures.

6. The computer system of claim 1, wherein the first and second elements collaborate to de-duplicate memory pages, the collaboration including intra-element and inter-element memory page de-duplication.

7. The computer system of claim 1, wherein the first and second data structures are shared with the de-duplication mechanism.

8. A computer program product comprising a computer readable storage device having computer readable program code embodied therewith, the program code being executable by a processing unit to de-duplicate one or more memory pages, the computer program product comprising:
a de-duplication mechanism supporting first and second de-duplication processes operatively coupled to first and second elements, respectively, the first and second de-duplication processes configured to operate in parallel;
program code to identify a first memory page and selectively de-duplicate the first memory page, including:
search a first data structure for a first matching entry representing a relatively identical memory page to the first memory page, and in response to identification of the first matching entry relatively identical to the first memory page, representing the first memory page and the first matching entry in the first data structure;
search a second data structure for a second matching entry relatively identical to the first memory page in response to absence of the first matching entry in the first data structure, and:
in response to absence of the first memory page, insert the first memory page in the second data structure; and
in response to presence of the first memory page, remove the first memory page from the second data structure, and represent the first memory page with a corresponding matching entry in the first data structure; and
program code to leverage transactional memory to resolve concurrent access of the first and second data structures.

9. The computer program product of claim 8, further comprising program code to create a first hash code representation of one or more memory pages local to the first element, and create a second hash code representation of one or more memory pages local to the second element.

10. The computer program product of claim 8, wherein the first and second data structures are disjoint-set data structures, each representing a dynamic collection and supporting operations to create a new set containing a single element, returning a representative element, and replacing a first element in a first set and a second element in a second set with a union in the dynamic collection.

11. The computer program product of claim 9, wherein the relatively identical memory page includes program code to apply a modulus operation to the first memory page based on a corresponding data structure size, and program code compare a value from the applied modulus operation to one or more entries in the corresponding data structure.

12. The computer program product of claim 11, wherein the selective de-duplication of the first memory page includes a two phase comparison wherein the value from the applied modulus operation is a first phase comparison, and further comprising program code to apply a second phase comparison responsive to relatively matching the first memory page with a page entry in one of the data structures, the second phase including comparison of content of the first memory page with content of the page entry in one of the data structures.

13. The computer program product of claim 8, wherein the program code supports collaboration of the first and second elements to de-duplicate memory pages, the collaboration including intra-element and inter-element memory page de-duplication.

14. A method comprising:
in a computer system configured with a de-duplication mechanism supporting first and second de-duplication processes operatively coupled to first and second elements, respectively, the two first and second de-duplication processes configured to operate in parallel;
identifying a first memory page and selectively de-duplicating the first memory page, including:
searching the first data structure for a first matching entry representing a relatively identical memory page to the first memory page, the relatively identical memory page operatively coupled to one of the first or second elements, and
in response to identification of the first matching entry relatively identical to the first memory page, representing the first memory page and the first matching entry in the first data structure;
searching the second data structure for a second matching entry relatively identical to the first memory page in response to absence of the first matching entry in the first data structure, and:
in response to absence of the first memory page, inserting the first memory page in the second data structure; and
in response to presence of the first memory page, removing the first memory page from the second data structure, and representing the first memory page with a corresponding matching entry in the first data structure; and
leveraging transactional memory for resolving concurrent access of the first and second data structures.

15. The method of claim 14, further comprising creating a first hash code representation of one or more memory pages local to the first element, and creating a second hash code representation of one or more memory pages local to the second element.

16. The method of claim 14, wherein the first and second data structures are disjoint-set data structures, each representing a dynamic collection and supporting operations to create a new set containing a single element, returning a representative element, and replacing a first element in a first set and a second element in a second set with a union in the dynamic collection.

17. The method of claim 15, wherein the relatively identical memory page includes applying a modulus operation to the first memory page based on a corresponding data structure size, and comparing a value from the applied modulus operation to one or more entries in the corresponding data structure.

18. The method of claim 17, wherein selectively de-duplicating the first memory page includes a two phase comparison wherein the value from the applied modulus operation is a first phase comparison, and further comprising applying a second phase comparison responsive to relatively matching the first memory page with a page entry in one of the data structures, the second phase including comparing content of the first memory page with content of the page entry in one of the data structures.

19. The method of claim 14, wherein the first and second elements collaborate to de-duplicate memory pages, the collaboration including intra-element and inter-element memory page de-duplication.

20. The method of claim 14, wherein the first and second data structures are shared with the de-duplication mechanism.
